(19) United States
(12) Patent Application Publication
(10) Pub. No.: US 2016/0318734 A1
(43) Pub. Date: Nov. 3, 2016

(54) ELEVATOR WITH AN ABSOLUTE POSITIONING SYSTEM FOR A DOUBLE-DECKER CAR

(71) Applicant: INVENTIO AG, Hergiswil (CH)

(72) Inventors: Rudolf J. Müller, Luzern (CH); Eric Birrer, Buchrain (CH)

(21) Appl. No.: 15/105,669

(22) PCT Filed: Nov. 13, 2014
(86) PCT No.: PCT/EP2014/074480

§ 371 Date: Jun. 17, 2016

(30) Foreign Application Priority Data
Dec. 18, 2013 (EP) 13198208.4

(51) Int. Cl. B66B 5/00; B66B 11/02; B66B 5/02; B66B 1/40

(52) U.S. Cl. CPC B66B 5/0018; B66B 1/40; B66B 11/022; B66B 5/02

(57) ABSTRACT

An elevator installation includes a first car and a second car, which cars are arranged on a car frame so as to be displaceable symmetrically in opposite directions. The elevator installation has an information carrier that is arranged along a region of travel of the first and second cars or of the car frame, a first sensor unit arranged on the first car, and a second sensor unit arranged on the second car. The first sensor unit and the second sensor unit are configured to read information from the information carrier, which information determines in each case an absolute position for the first car and for the second car.

### FIELD

The invention relates to an elevator with an absolute positioning system for a double-decker car.

### BACKGROUND

Known from JP 2013-095572 A is an elevator system with a double-decker car. The known elevator system exhibits a car frame in which two cars are situated vertically one over the other. The two cars are each suspended at one end of a hoist rope. The car frame is further provided with a drive unit, around which the hoist rope is guided. The hoist rope is here in active contact with a drive roller of the drive. By actuating the hoist rope with the drive unit, the cars suspended in this way can be lifted and lowered relative to the car frame. In this way, the two cars can be varyingly positioned inside of the car frame.

In order to acquire a position of the cars in the car frame, the elevator system from JP 2013-095572 A is equipped with a first sensor unit, which measures the position of the first car relative to the car frame, and with a second sensor unit, which measures the position of the second car relative to the car frame. In addition, the elevator system encompasses a third sensor unit, which acquires the position of the car frame relative to the shaft. As a consequence, evaluating the position data also makes it possible to calculate a position of the cars relative to the shaft. However, the disadvantage is that the positioning system of the elevator system with three sensor units is relatively complicated and expensive.

### SUMMARY

Therefore, an object of the invention is to provide an elevator system with a positioning system for a double-decker car that is simple and inexpensive.

The elevator system preferably encompasses a first and second car, which are arranged on a car frame so that they can be symmetrically adjusted in opposite directions. In addition, the elevator system encompasses an information carrier, which is situated along the first travel range of the first and second car or of the car frame. The elevator system further has a first sensor unit arranged on the first car, and a second sensor unit arranged on the second car. The first sensor unit and second sensor unit are here configured to read information from the information carrier intended to determine an absolute position for the respective first and second cars.

Provided for adjusting the cars is an adjustment drive, which preferably is arranged on the car frame. Suitable adjustment drives include traction drives, hydraulic drives, spindle drives and the like, which are operatively connected with the cars.

The information carrier is preferably configured as a code carrier. Suitable code carriers include bands that are suspended in the travel area of the cars or applied to a guide rail, for example. Correspondingly, the read information is present as code words, which can be read by the first and second sensor unit from the information carrier or code carrier.

In comparison to prior art, the elevator system preferably has only two sensor units. As a result, the positioning system is greatly simplified, and correspondingly also less expensive to procure.

Since both cars can be simultaneously adjusted in varying directions, a desired distance between the cars can be set especially quickly. In addition, the two cars can be coupled in such a way that the respective car weights can be mutually compensated, and correspondingly less adjustment power is required from the adjustment drive.

The first and second sensor units preferably have allocated to them a shared safety control unit, which calculates an absolute position and/or absolute speed based on the read information.

Alternatively, the first and second sensor units each have allocated to them a processor, which calculates an absolute position and/or absolute speed based on the read information, wherein the processors are connected with a shared safety control unit.

In another alternative, the first and second sensor units each have allocated to them a processor, which calculates an absolute position and/or absolute speed based on the read information, wherein the processors are connected with each other via a data line, and each processor has an absolute position and/or absolute speed of the other processor.

Absolute position is understood as a clearly determinable position relative to a bordering of the travel area of the cars. The travel area is typically bordered by a shaft, a support structure, an outer wall of a building or the like. The absolute speed of a car can be calculated by deriving the read position information over time. Accordingly, the absolute speed represents a speed of the cars relative to the bordering. The absolute speed consists of the relative speed of the cars relative to the car frame as well as the speed of the car frame relative to the bordering.

It is especially advantageous to directly determine the absolute position and absolute speed, since this eliminates the need for a relatively complicated calculation of the absolute speed by overlapping the relative speed of the cars and the speed of the car frame.

A respective processor or the safety control unit is preferably configured to calculate an absolute position and/or absolute speed of the car frame based on the absolute positions and absolute speeds of the cars. Thanks to the symmetrically opposing adjustability of the cars, the absolute position of the car frame can also be determined if both absolute positions of the cars are known.

A respective processor or the safety control unit is preferably configured to compare the absolute position of the car frame with a previously stored final position, so as to determine whether a final position was overshot. In addition, a respective processor or the safety control unit can be configured to compare the absolute position of the respective car with a previously stored floor position area, so as to determine whether the car or shaft door contacts can be bridged. Finally, a respective processor or the safety control unit can be configured to compare the absolute speed for an absolute position of the car frame with a previously stored permissible, position-dependent speed, so as to determine whether an operating curve, in particular a final operating curve, was exceeded.

The floor position areas and maximum travel paths within the car frame are preferably read in and stored during a learn trip. The floor positions can be indicated by position magnets discernible from the sensor units. The final positions, the floor position areas along with the permissible speeds or operating curves, in particular final operating curves, can be calculated from the data of the learn trip as well as prescribed system parameters, such as the fair values for premature door opening, maximum permissible speeds and the like.

A floor position area is to be understood as a position area situated around a floor position. The floor position area takes into account the possibility of a premature car or shaft door opening, as well as a tolerance range owed to the rope elongation. A final position represents a position in the travel range that the car frame cannot overshoot during the safe operation of the elevator system, so as to avoid a collision between the car frame and travel range ends. In this conjunction, the final operating curves also contribute. Monitoring the final operating curves makes it possible to safely stop the car frame before a travel range end, or prevent it from exceeding a permissible speed when approaching a motion buffer. In general, monitoring the travel curves ensures that the car frame is stopped along the entire travel range in the event of overspeed.

In cases where it is determined that the final position was overshot, the door has impermissibly opened outside a floor position area, or the travel curve has been exceeded, a respective processor or the safety control unit is preferably configured to implement a measure, in particular initiate an emergency stop and/or a safety braking, so as to bring the elevator system to a safe condition.

In cases where it is determined that the final position, as calculated from the absolute positions of the two cars when the upper car is positioned on the second lowest floor and the lower car on a lowest floor, has been overshot, a respective processor or the safety control unit is preferably configured to implement a measure, in particular initiate an emergency stop and/or safety braking, so as to bring the elevator to a safe condition.

Alternatively, in cases where it is determined that the final position, as calculated from the absolute positions of the two cars when the upper car is positioned on the second lowest floor and the lower car assumes a lowest position relative to the car frame, has been overshot, a respective processor or the safety control unit is preferably configured to implement a measure, in particular initiate an emergency stop and/or safety braking, so as to bring the elevator to a safe condition. It is here especially advantageous that the lower car be able to move under the position of the lowest floor, and that the car distance not have to be readjusted during a learn trip of the lower car.

In another alternative, in cases where it is determined that the final position, as calculated from the absolute positions of the two cars when the lower car is positioned on a lowest floor and the upper car assumes a lowest position relative to the car frame, has been overshot, a respective processor or the safety control unit is preferably configured to implement a measure, in particular initiate an emergency stop and/or safety braking, so as to bring the elevator to a safe condition. It is here especially advantageous that the upper car be able to move under the position of the second lowest floor, and that the car distance not have to be readjusted during a learn trip of the lower car.

The elevator system preferably has at least one motion buffer, which limits a lower travel range of the car frame. A distance between the motion buffer and a final position of the car frame is here dimensioned in such a way that a minimal distance between the motion buffer and car frame can be maintained even if the lower car is positioned on a lowest floor and the upper car on a second lowest floor. In this configuration, it is advantageous that a shaft pit can be kept as small as possible.

Alternatively, the elevator system has at least one motion buffer, which limits a lower travel range of the car frame. A distance between the motion buffer and a final position of the car frame is here dimensioned in such a way that a minimal distance between the motion buffer and car frame can be maintained even if the upper car is positioned on a second lowest floor and assumes a top position relative to the car frame. It is here advantageous to provide a somewhat deeper shaft pit, so as not to have to adjust the distance between the cars during learn trips of the lower car.

In another alternative, the elevator system has at least one motion buffer, which limits a lower travel range of the car frame. A distance between the motion buffer and a final position of the car frame is here dimensioned in such a way that a minimal distance between the motion buffer and car frame can be maintained even if the lower car is positioned on a lowest floor and assumes a top position relative to the car frame. It is here advantageous to provide an even deeper shaft pit, so as not to have to adjust the distance between the cars during learn trips of the lower car.

Of course, a respective processor is also configured to monitor a final position relative to an upper travel range end. The previous statements applicable to a lower travel range end can here be carried over to a situation involving an upper travel range end. Correspondingly, a final position is monitored as a function of the stop conditions of the upper and lower car relative to a top floor or second from the top floor. In addition, at least one upper motion buffer is provided at the upper travel range end. The minimal distance between the upper motion buffer and a final position of the car frame can be configured analogously to a minimal distance between the lower motion buffer and car frame.

### DESCRIPTION OF THE DRAWINGS

A better description of the invention will be provided below based on exemplary embodiments. Shown on:

FIG. 1a is a schematic view of an elevator system with an absolute positioning system for a double-decker car in a first situation;

FIG. 1b is a schematic view of the double-decker car in a second situation; and

FIG. 1c is a schematic view of the double-decker car in a third situation.

### DETAILED DESCRIPTION

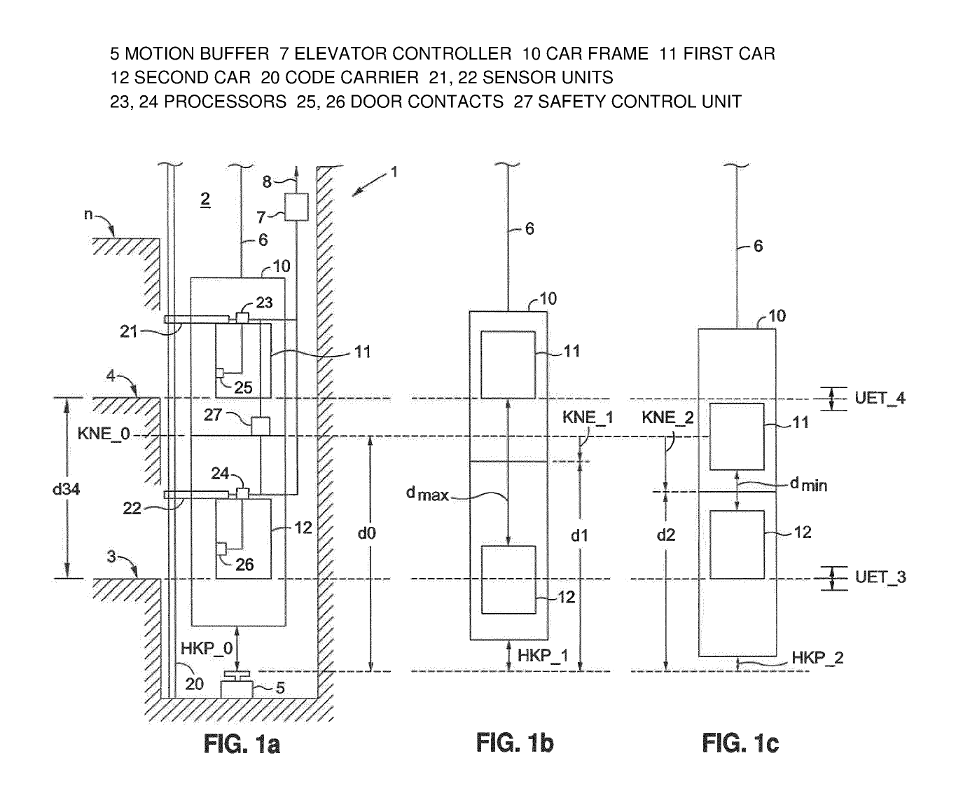

FIG. 1a shows an elevator system 1 with at least one car frame 10, which can be moved in a travel range 2 provided for a trip by the car frame 10. For example, the travel range 2 can be provided in a shaft of a building.

The car frame 10 is suspended at one end of a traction means 6. The traction means 6 is guided at least around one traction sheave of a drive. The drive is here arranged in the shaft or in a separate room. The car frame 10 is moved up or down through the travel range 2 according to a current rotational direction of the traction sheave. Alternatively, the car frame 10 can also be suspended via a centrally arranged pulley or several pulleys on the traction means 6 in a suspension ratio of 2:1. Of course, the expert can also realize higher suspension ratios depending on the requirements placed on the elevator system 1.

A first car 11 and a second car 12 are adjustably arranged on the car frame 10. The first car 11 is here situated above the second car 12. The car frame 10 exhibits at least two side members, which are joined together by a lower cross member, an upper cross member and a central cross member. The car carrier has an adjustment unit, which can be used to adjust the first and second cars 11, 12 in the car frame 10. For example, an adjustment unit can be fastened to the upper cross beam, which serves to drive an additional traction sheave. The additional traction sheave is here joined with the adjustment unit by a shaft. The first and second cars 11, 12 are each suspended on one end of an additional traction means. The additional traction means runs over the additional traction sheave, and is in active contact with the latter, so that a rotational movement of the additional traction sheave is transferred to the additional traction means.

The distance between the cars 11, 12 can be varied by means of the adjustment unit. Depending on the rotational direction of the additional traction sheave, the distance is here enlarged or reduced within specific limits. For example, a floor distance can vary within a building. In particular, a floor distance d34 relative to a lobby can be greater than an otherwise provided floor distance. For example, the distance between the cars 11, 12 proceeding from a minimal distance dmin can be increased by up to 3 m. An adjustment track for the first car 11 is a least approximately the same size as an adjustment track for the second car 12. Further, the two cars 11, 12 are adjusted in opposite directions to each other.

An advantageous equilibrium of forces here arises between the weight forces of the two cars 11, 12. The one car 11 here acts as a counterweight to the other car 12. As a consequence, the adjustment unit at least essentially has to apply only one torque to the additional traction means, which is sufficient to overcome the unbalanced weight force and system frictions between the two cars 11, 12.

The drive of the elevator system is controlled by an elevator controller 7. The elevator controller 7 is connected with the drive by a line. This is denoted by an arrow 8 on FIG. 1a. In response to car calls or destination entries, the elevator controller 7 instructs the drive to move the car frame 10 or cars 11, 12 to floors 3, 4, n. To this end, the elevator controller 7 is connected with an absolute positioning system, which continuously relays information to the elevator controller 7 about the position of the cars 11, 12 or car frame 10.

The absolute positioning system encompasses at least one code carrier 20, which here is depicted as a code strip suspended in the travel range 2 of the car carrier 10. Additionally provided in the system are sensor units 21, 22, which read a code on the code carrier 20. A first sensor unit 21 is allocated to the first car 11, and a second sensor unit 22 to the second car 12. A processor 23, 24 is allocated to each of these sensor units 21, 22. The processor can evaluate the code provided by the sensor units 21, 22, and calculate a current absolute position of the respective car 11, 12.

In the example shown on FIG. 1a, the two processors 23, 24 are connected with a safety control unit 27. The respective processors 23, 24 transmit the calculated absolute positions of the cars 11, 12 to the safety control unit 27. The safety control unit 27 is able to calculate an absolute position for the car frame 10 using the absolute positions of the cars 11, 12 and in light of the symmetrically opposed movability of the cars 11, 12 within the car frame 10.

In an alternative configuration (not shown), the two sensor units 21, 22 can also be directly connected with the safety control unit 27. Accordingly, no separate processors 23, 24 are provided. Incoming sensor signals are evaluated in the safety control unit 27, so that both the absolute positions of the cars 11, 12 and the absolute position of the car frame 10 are calculated in the safety control unit 27.

In yet another alternative configuration (not shown), the processors 23, 24 are connected directly with each other, and correspondingly exchange absolute positions of the respective cars 11, 12. In this configuration, each processor 23, 24 can separately calculate an absolute position of the car frame 10 based on the information it was provided about the absolute position of both cars 11, 12.

Of course, the processors 23, 24 or safety control unit 27 can also calculate an absolute speed of the car frame 10 proceeding from the absolute positions of the cars 11, 12 and the car frame 10.

The absolute positions of the cars 11, 12 can be used to decide whether a car door of a respective car 11, 12 or an approached floor 3, 4, n is permissibly open. The state of the car doors is monitored with a respective door contact 25, 26. The door contacts 25, 26 are connected with the processors 23, 24 by a line. When the car doors open, the allocated door contact 25, 26 is interrupted. This interruption is detected by the processors 23, 24. Accordingly, the processors 23, 24 or the safety controller 27 implement a measure, preferably initiate an emergency stop and/or safety braking, so as to bring the elevator system to a safe condition upon detection of an impermissible opening.

Since the car doors preferably already open shortly before reaching a floor 3, 4, n, and a rope elongation must be accepted within a certain tolerance range, a certain area UET_3, UET_4 arises in which a car door is permissibly open. In these floor areas UET_3, UET_4, the door contacts 25, 26 can be bridged so that continued operation of the elevator system 1 can be maintained.

FIG. 1 a depicts the elevator system in a first situation, in which the car frame 10 has moved into a lower travel range 2. Correspondingly, the upper car 11 services a second to lowest floor 4, and the lower car 12 services a lowest floor 3. The two floors 3, 4 are spaced apart by a distance d34. In this situation, an absolute position of the car frame 10 can be calculated proceeding from the absolute positions of the two cars 11, 12. The latter absolute position is compared with a final position KNE_0. The final position KNE_0 represents a lowest position that can be approached by the car frame 10. If this final position KNE_0 is overshot, the processors 23, 24 or the safety control unit 27 implement measures to prevent a collision between the car frame 10 and a lower structure of the shaft 2, or maintain a maximum permissible approach speed of the car frame 10 to a motion buffer 5. To this end, the safety control unit 27 prompts the drive to engage an emergency stop and/or a safety brake situated on the car frame 10.

As an option, the processors 23, 24 or safety control unit 27 can also monitor compliance with a maximum permissible speed, preferably depending on position. The position-dependent permissible speeds are presented as operating curves, in particular also final curves. The processors 23, 24 or safety control unit 27 here compare an absolute speed with the permissible speed or an absolute position speed for an absolute position with a position-dependent permissible speed. If the permissible speed is exceeded, the processors 23, 24 or safety control unit 27 implement measures, for example initiate an emergency stop and/or a safety braking, so as to bring the elevator system 1 to a safe condition.

The floor areas UET_3, UET_4 are read in and stored as part of a learn trip. In addition, the learn trip involves moving the cars 11, 12 into their extreme positions inside of the car frame 10. Based on this information, a final position KNE_0 can be calculated and stored as a reference value. A tolerated rope elongation is factored in when determining the final position KNE_0.

A motion buffer 5 is provided in the shaft pit, and buffers an approach of the car frame 10. The distance d0 between the motion buffer 5 and final position KNE_0 is dimensioned in such a way that a minimum distance HKP_0 can be maintained between the car frame 10 and motion buffer 5. HKP 0 defines a distance between the car frame 10 and motion buffer 5 when the cars 11, 12 are on the floor 3, 4. The distance HKP_0 is more largely dimensioned than an allocated ride between a floor 3, 4 and the final position KNE_0. The final position KNE_0 typically lies 100 mm below the last floor 3, 4. HKP_0 thus measures more than 100 mm.

FIG. 1b shows a second situation of the car frame 10 in a lower area of the shaft 2. The upper car 11 is positioned on a floor 4 therein, and the lower car 12 assumes a lowest position relative to the car frame 10. There is here a maximal distance dmax between the cars 11, 12. As a consequence, the location of the car frame 10 shifts downwardly. The permissible final position KNE_1 is set deeper accordingly. The distance dl between the motion buffer 5 and final position KNE_1 is selected in such a way that a minimum distance HKP_1 can be maintained between the car frame 10 and motion buffer 5.

FIG. 1c shows a third situation of the car frame 10 in a lower area of the shaft 2. The lower car 12 is positioned on a floor 3 therein, and the upper car 12 assumes a lowest position relative to the car frame. There is here a minimal distance dmin between the cars 11, 12. As a consequence, the location of the car frame 10 shifts even further downwardly. The permissible final position KNE_2 is set deeper accordingly. The distance d2 between the motion buffer 5 and final position KNE_2 is selected in such a way that a minimum distance HKP_2 can be maintained between the car frame 10 and motion buffer 5.

In the second and third situations, one respective car 12 or 11 is empty, and only the other car 11 or 12 is moved to a floor 4 or 3. In these situations, the car distance potentially need not be adjusted. By contrast, the shaft pit might possibly have to made deeper. This provides greater leeway in operating the elevator system 1.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. An elevator system having a first car and a second car, which cars are arranged on a car frame for symmetrical adjustment in opposite directions, comprising:
an information carrier situated along a travel range of the first and second cars or of the car frame;
a first sensor unit arranged on the first car; and
a second sensor unit arranged on the second car, wherein the first sensor unit and second sensor unit are configured to read information from the information carrier for determining at least one of an absolute position and an absolute speed for the respective first and second cars.

17. The elevator system according to claim 16 characterized wherein the first and second sensor units are connected to a shared safety control unit and the control unit calculates the at least one of the absolute position and the absolute speed based on the read information.

18. The elevator system according to claim 16 wherein the first and second sensor units each are connected to a processor and the processors calculate the at least one of the absolute position and the absolute speed based on the read information, and wherein the processors are connected with a shared safety control unit.

19. The elevator system according to claim 16 wherein the first and second sensor units each are connected to a processor that calculates the at least one of the absolute position and the absolute speed based on the read information, wherein the processors are connected with each other via a data line and each of the processors has the at least one of the absolute position and the absolute speed calculated by both of the processors.

20. The elevator system according to claim 16 wherein the first and second sensor units are connected to a respective processor or a safety control unit, the processors and the safety control unit being configured to calculate at least one of an absolute position and an absolute speed of the car frame based on the at least one of the absolute positions and the absolute speeds of the first and second cars.

21. The elevator system according to claim 20 wherein the respective processor or the safety control unit is configured to compare the absolute position of a respective one of the first and second cars with a previously stored floor position area to determine whether car or shaft door contacts can be bridged.

22. The elevator system according to claim 20 wherein the respective processor or the safety control unit is configured to compare the absolute speed for an absolute position of the car frame with a previously stored permissible speed for a position to determine whether an operating curve was exceeded.

23. The elevator system according to claim 20 wherein the respective processor or the safety control unit is configured to compare the absolute position of the car frame with a previously stored final position to determine whether the final position was overshot.

24. The elevator system according to claim 23 wherein when it is determined that the final position was overshot, impermissible bridging has occurred outside a floor position area, or a travel curve has been exceeded, the respective processor or the safety control unit implements a measure to bring the elevator system to a safe condition.

25. The elevator system according to claim 24 wherein the measure is at least one of an emergency stop and a safety braking.

26. The elevator system according to claim 23 wherein when it is determined that the final position, as calculated from the absolute positions of the first and second cars when the first car is positioned on a second lowest floor and the second car is positioned on a lowest floor, has been overshot, the respective processor or the safety control unit implements a measure to bring the elevator system to a safe condition.

27. The elevator system according to claim 26 wherein the measure is at least one of an emergency stop and a safety braking.

28. The elevator system according to claim 23 wherein when it is determined that the final position, as calculated from the absolute positions of the first and second cars when the first car is positioned on a second lowest floor and the second car assumes a lowest position relative to the car frame, has been overshot, the respective processor or the safety control unit implements a measure to bring the elevator system to a safe condition.

29. The elevator system according to claim 28 wherein the measure is at least one of an emergency stop and a safety braking.

30. The elevator system according to claim 23 wherein when it is determined that the final position, as calculated from the absolute positions of the first and second cars when the second car is positioned on a lowest floor and the first car assumes a lowest position relative to the car frame, has been overshot, the respective processor or the safety control unit implements a measure to bring the elevator system to a safe condition.

31. The elevator system according to claim 30 wherein the measure is at least one of an emergency stop and a safety braking.

32. The elevator system according to claim 16 including a motion buffer that limits a lower travel range of the car frame, wherein a distance between the motion buffer and a final position of the car frame is such that a minimal distance between the motion buffer and car frame is maintained even if the first car is positioned on a second lowest floor and assumes a top position relative to the car frame.

33. The elevator system according to claim 16 including a motion buffer that limits a lower travel range of the car frame, wherein a distance between the motion buffer and a final position of the cabin frame is such that a minimal distance between the motion buffer and car frame is maintained even if the second car is positioned on a lowest floor and assumes a top position relative to the car frame.

34. The elevator system according to claim 16 including a motion buffer that limits a lower travel range of the car frame, wherein a distance between the motion buffer and a final position of the car frame is such that a minimal distance between the motion buffer and car frame is maintained even if the second car is positioned on a lowest floor and the first car is positioned on a second to lowest floor.
